(19) United States
(12) Patent Application Publication
(10) Pub. No.: US 2025/0221338 A1
(43) Pub. Date: Jul. 10, 2025

(54) LAWN MAINTENANCE DEVICE WITH BLOWER ASSISTED BAGGING

(71) Applicant: MTD PRODUCTS INC, Valley City, OH (US)

(72) Inventors: Justin J. Chae, Strongsville, OH (US); Christian P. Emhoff, Medina, OH (US)

(21) Appl. No.: 19/014,517

(22) Filed: Jan. 9, 2025

Related U.S. Application Data
(60) Provisional application No. 63/619,080, filed on Jan. 9, 2024.

(51) Int. Cl. A01D 43/08; A01D 34/66

(52) U.S. Cl. CPC A01D 43/086; A01D 34/66

(57) ABSTRACT

Provided is a lawn maintenance device with blower assisted bagging. The device has a deck having a blade set adapted to be operated at some blade speed to trim vegetation to generate trimmings; said deck further having a deck output adapted to eject a trimming mixture formed of the trimmings and air. The device has a discharge chute defining a chute input and a chute output, the chute output offset from the chute input by a chute elongation path; the chute input operatively engaged to the deck output to receive the trimming mixture; the discharge chute adapted to convey trimming mixture to the chute output. The device has an electric blower having a blower intake and a blower ejection; the blower adapted to operate at some blower speed to output an energized fluid stream into the discharge chute at a location between the chute input and the chute output.

### CROSS-REFERENCE TO RELATED APPLICATIONS

This application claims the benefit of U.S. Provisional Application No. 63/619,080, filed Jan. 9, 2024, and which is hereby incorporated by reference within the present disclosure in its entirety and for all purposes.

### FIELD OF DISCLOSURE

The disclosed subject matter pertains to apparatuses and methods for power equipment for lawn maintenance applications. More specifically the disclosed subject matter pertains to apparatuses and methods for a lawn maintenance device adapted to bag debris.

Manufacturers of power equipment for lawn maintenance applications offer many types of machines for general maintenance and mowing applications. Generally, these machines can have a variety of forms depending on application, from general urban or suburban lawn maintenance, rural farm and field maintenance, to specialty applications. Even specialty applications can vary significantly from sporting events requiring moderately precise turf, such as soccer fields or baseball outfields, to events requiring very high-precision surfaces such as golf course greens, tennis courts and the like.

Power equipment for lawn maintenance applications may include equipment adapted to be operated to trim vegetation, such as grass or weeds or other plants, to generate trimmings. Power equipment for lawn maintenance applications may include equipment adapted to collect trimmings or other debris and to convey such collected trimmings or debris in an air mixture to a storage receptacle. One problem that exists is that trimmings or debris, especially when wet, can be difficult to convey from a collection point to the storage receptacle and some of the trimmings or debris may build up in the conveyance path if not properly conveyed. One solution to this issue has been to incorporate a bagging assist blower to add additional air volume or speed to the mixture of air and trimmings or debris. In gas powered equipment incorporating a blower, typically the blower is placed local to a mechanical power take-off such as a belt operationally connected to a blade shaft in a mow deck. In such systems, the blower speed is typically fixed with respect to the blade speed in the mow deck. While such arrangements may be inefficient due to the inflexibility of blower placement or inability to change blower speed relative to the blade speed, given the generous amounts of power available in gas powered equipment such inefficiencies have previously been tolerable. By contrast, in electrically powered power equipment for lawn maintenance applications, the power demands for a bagging assist blower can become an issue, such that efficiency is a concern.

It remains desirable to develop power efficient bagging assist blower apparatuses and methods for use in association with an electrically powered lawn maintenance device.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

In a first embodiment, disclosed is a lawn maintenance device with blower assisted bagging. The device has a deck having a blade set adapted to be operated at some blade speed to trim vegetation to generate trimmings; said deck further having a deck output adapted to eject a trimming mixture formed of the trimmings and air. The device has a discharge chute defining a chute input and a chute output, the chute output offset from the chute input by a chute elongation path; the chute input operatively engaged to the deck output to receive the trimming mixture; the discharge chute adapted to convey trimming mixture to the chute output. The device has an electric blower having a blower intake and a blower ejection; the blower adapted to operate at some blower speed to output an energized fluid stream into the discharge chute at a location between the chute input and the chute output.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 depicts a non-limiting example of a lawn maintenance device with blower assisted bagging.

FIG. 2 illustrates one aspect of a discharge chute in operational engagement with a deck and indicating possible locations and orientations for an electric blower.

FIG. 3 illustrates another aspect of a discharge chute in operational engagement with a deck and indicating possible locations and orientations for an electric blower.

FIG. 4 illustrates one aspect of a discharge chute in operational engagement with a deck and with one possible location and orientation for an electric blower and further depicting the flow stream of the chute.

FIG. 5 is another depiction of the lawn maintenance device with blower assisted bagging of FIG. 1 further depicting the flow stream of the chute.

FIG. 6 depicts a blower in parallel engagement with the deck.

FIG. 7 depicts a blower in series engagement with the deck.

FIG. 8 depicts a blower in hybrid engagement with the deck.

FIG. 9 illustrates an example of a blower in parallel engagement with the deck.

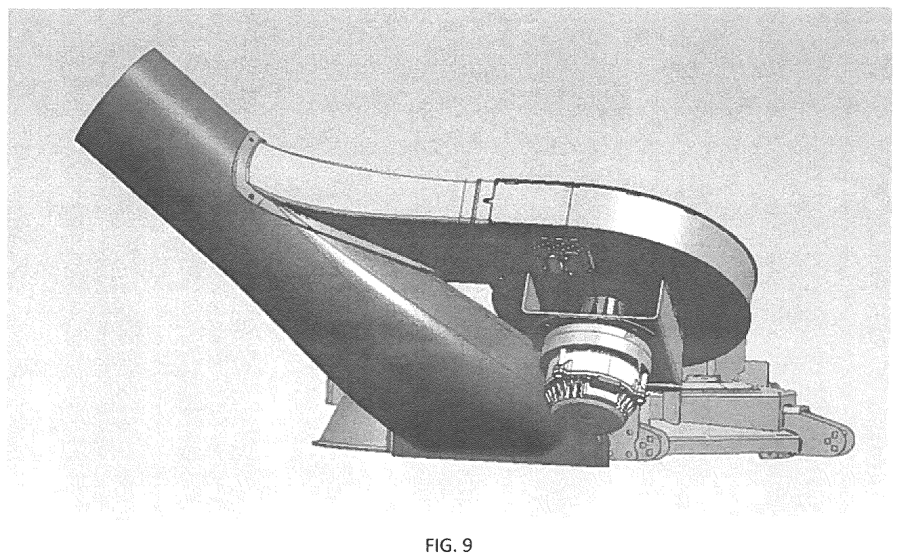

FIG. 10 illustrates a first example of a blower in hybrid engagement with the deck shown engaged at a first angle.

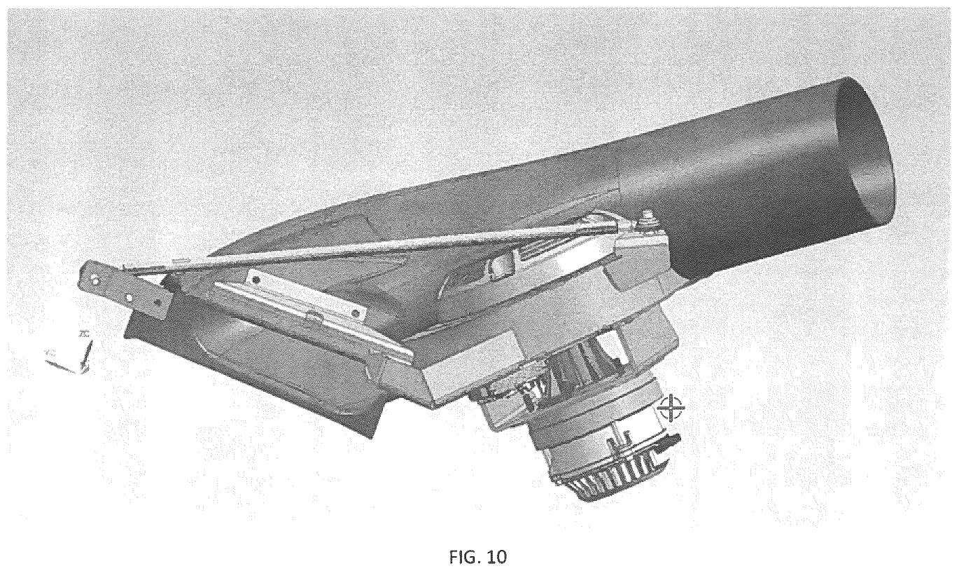

FIG. 11 is another view of the example of FIG. 10.

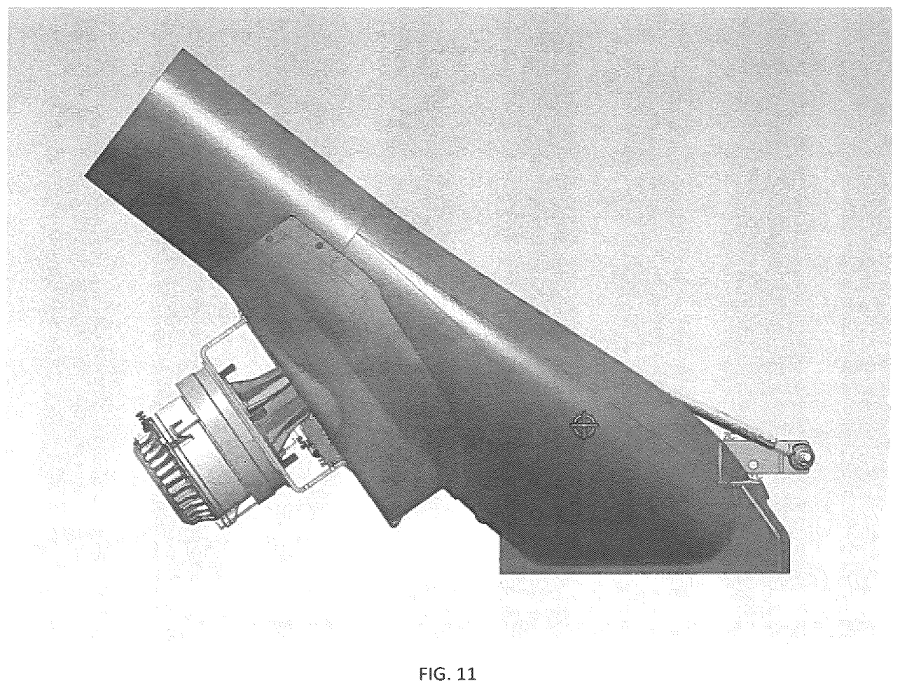

FIG. 12 illustrates a second example of a blower in hybrid engagement with the deck shown engaged at a second angle with the chute.

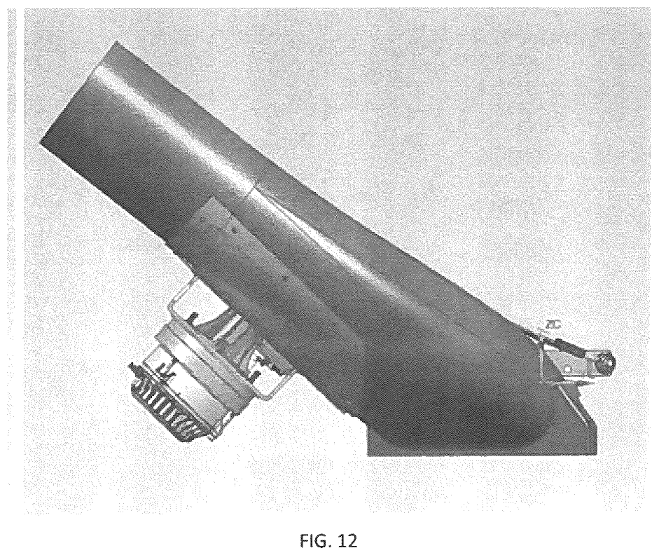

FIG. 13 is a comparison view of the example of FIG. 10 and the example of FIG. 12 with the blower housing shown partially invisible for purposes of clarity.

FIG. 14 is another view of the example of FIG. 10.

FIG. 15 is another view of the example of FIG. 10.

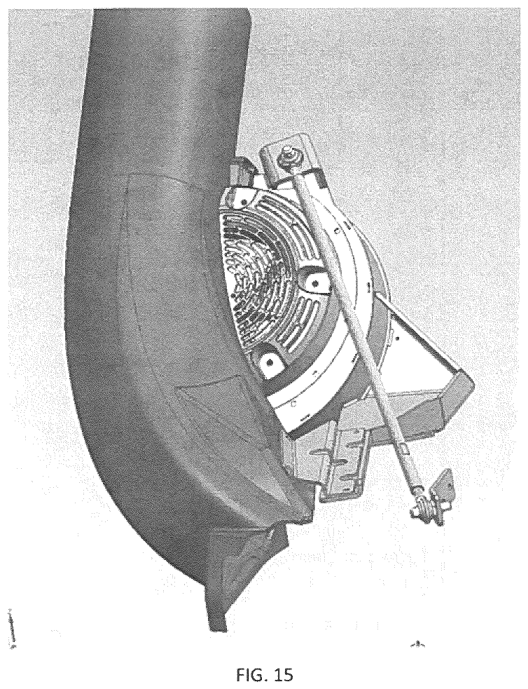

FIG. 16 is a block diagram of a bottom view of a mow deck showing the blades.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to a lawn maintenance device with blower assisted bagging are described herein, it should be understood that the disclosed machines, electronic apparatus and computing devices and methods are not so limited, and modifications may be made without departing from the scope of the present disclosure. The scope of the machines, apparatuses, methods, and devices are defined by the appended claims, and all devices, processes, and methods that come within the meaning of the claims, either literally or by equivalence, are intended to be embraced therein.

### DETAILED DESCRIPTION

The following terms are used throughout the description, the definitions of which are provided herein to assist in understanding various aspects of the subject disclosure.

As used in this application, the terms “outdoor power equipment”, “outdoor power equipment machine”, “power equipment”, “maintenance machine”, “power equipment machine”, and “lawn maintenance device” are used interchangeably and are intended to refer to any of robotic, partially robotic ride-on, walk-behind, sulky equipped, autonomous, semi-autonomous (e.g., user-assisted automation), remote control, or multi-function variants of any of the following: powered carts and wheelbarrows, lawn mowers, lawn and garden tractors, lawn trimmers, lawn edgers, lawn and leaf blowers or sweepers, hedge trimmers, pruners, loppers, chainsaws, rakes, pole saws, tillers, cultivators, aerators, log splitters, post hole diggers, trenchers, stump grinders, snow throwers (or any other snow or ice cleaning or clearing implements), lawn, wood and leaf shredders and chippers, lawn and/or leaf vacuums, pressure washers, lawn equipment, garden equipment, driveway sprayers and spreaders, and sports field marking equipment.

As utilized herein, relative terms or terms of degree such as approximately, substantially, about, roughly and so forth, are intended to incorporate ranges and variations about a qualified term reasonably encountered by one of ordinary skill in the art in fabricating or compiling the embodiments disclosed herein, where not explicitly specified otherwise. For instance, a relative term can refer to ranges of manufacturing tolerances associated with suitable manufacturing equipment (e.g., injection molding equipment, extrusion equipment, metal stamping equipment, and so forth) for realizing a mechanical structure from a disclosed illustration or description. In some embodiments, depending on context and the capabilities of one of ordinary skill in the art, relative terminology can refer to a variation in a disclosed value or characteristic, e.g., a 0 to five-percent variance or a zero to ten-percent variance from precise mathematically defined value or characteristic (which is included in the range), or any suitable value or range there between can define a scope for a disclosed term of degree. As an example, a power equipment device can have an operating dimension, such as a heading measurement, average velocity estimate, relative position estimate, or the like, with a variance of 0 to five percent or 0 to ten percent. As another example, a disclosed mechanical dimension can have a variance of suitable manufacturing tolerances as would be understood by one of ordinary skill in the art, or a variance of a few to several percent about the disclosed mechanical dimension that would also achieve a stated purpose or function of the disclosed mechanical dimension. These or similar variances can be applicable to other contexts in which a term of degree is utilized herein such as relative position of a disclosed element, speed of a disclosed motor in rotations per minute (or other suitable metric), accuracy of measurement of a physical effect (e.g., a heading measurement, an acceleration measurement, a relative velocity, etc.) or the like. In addition to the foregoing, it should be understood that the drawings appended to this specification are not drawn to scale, unless explicitly stated in the description herein or on the drawing.

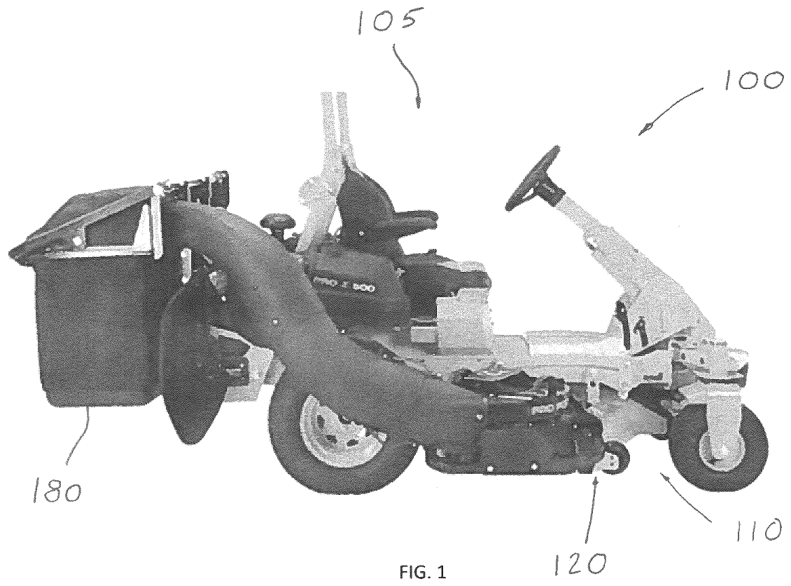

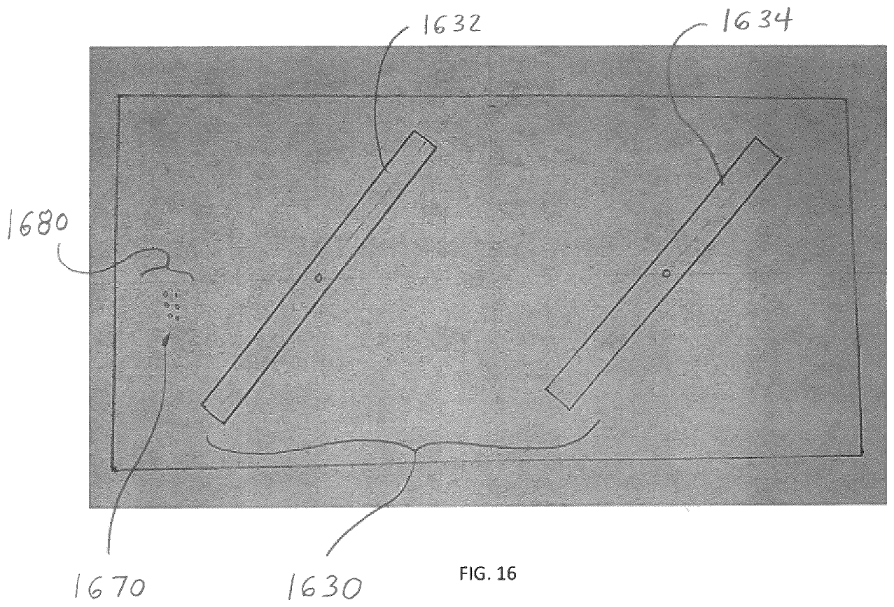

FIG. 1 illustrates a side view of a lawn maintenance device 100 with blower assisted bagging. In FIG. 1 and without limitation, the lawn maintenance device 100 is a lawn mower 105. The lawn maintenance device 100 shown in FIG. 1 is a gas-powered device, but this is not limiting and the lawn maintenance device 100 may be an electrically powered device. Whether gas-powered or electrically powered, in those non-limiting embodiments in which the lawn maintenance device 100 is a lawn mower 105, it may comprise a mow deck 110. A mow deck 110 may comprise a deck output 120. With further reference now to FIG. 16, a mow deck 110 may comprise a blade set 1630. The blade set 1630 may comprise a first blade 1632, a second blade 1634, or more blades. In operation, the blade set 1630 may be driven by a set of blade motors (not shown) to operate at some blade speed to trim vegetation to generate trimmings 1670. As used herein, blade speed can vary between zero and some operational maximum blade speed. The trimmings 1670 may be mixed with air to form a trimming mixture 1680 of the trimmings suspended in the air. The trimming mixture 1680 may be ejected from the mow deck 110 through the deck output 120. Blower assisted bagging uses a blower to promote flow of a mixture of the trimming mixture 1680 into a bag 180 or other receptacle.

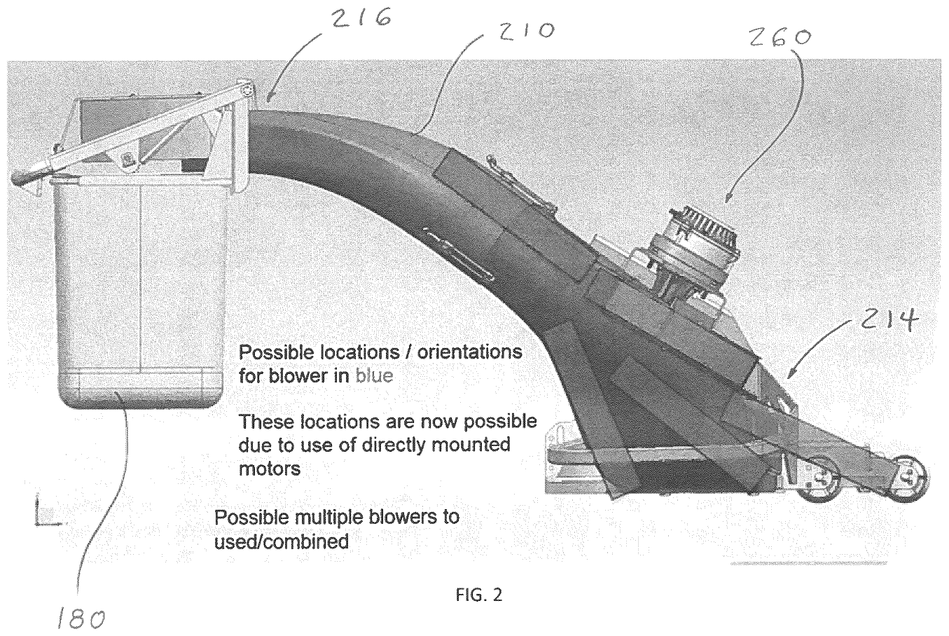

FIG. 2 illustrates a side view of one aspect of a discharge chute 210 in operational engagement with a mow deck 110 and indicating possible locations and orientations for an electric blower 260 adapted to provide blower assisted bagging. In FIG. 2, the mow deck 110 may be the mow deck 110 of lawn mower 105, but it could also be the deck of other sorts of lawn maintenance devices such as, without limitation, a lawn vacuum. In some embodiments, discharge chute 210 is operationally engaged with mow deck 110 at the deck output 120.

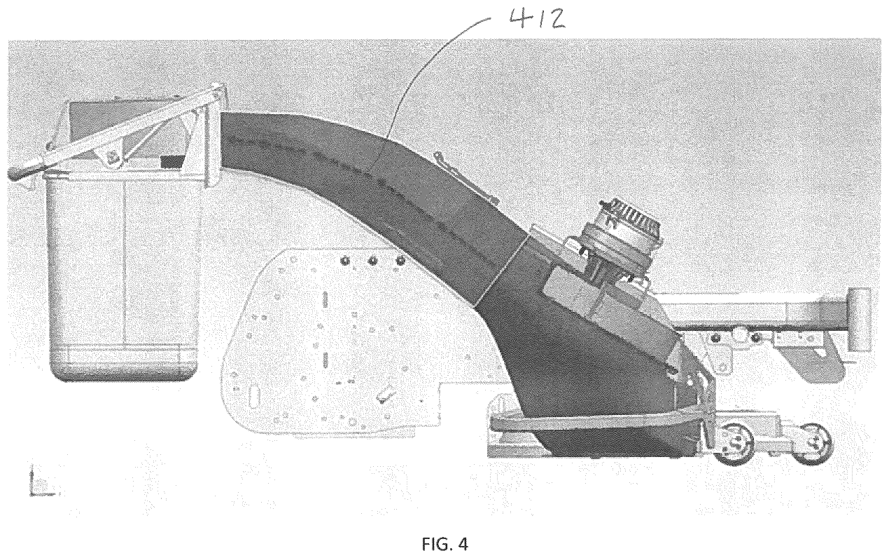

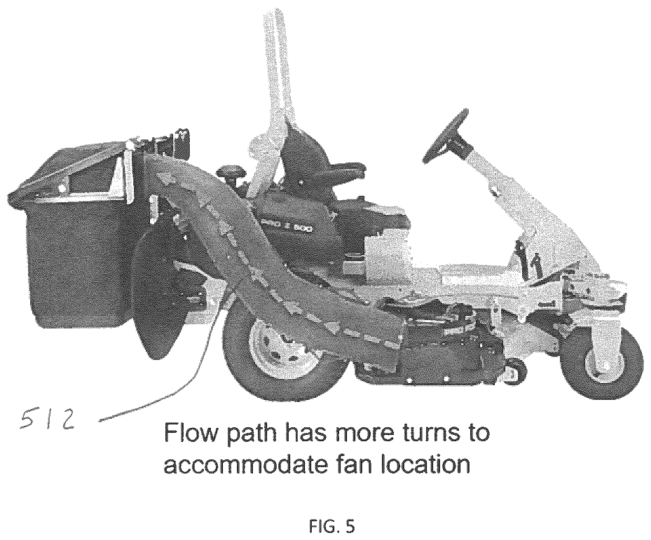

It should be understood that the electrical power supply of an electric lawn mower may be used to power an electric blower 260. In embodiments in which an electric blower 260 is used, efficient supply of power to the electric blower 260 does not depend on placement local to a mechanical power take off; to the contrary, efficient supply of power to the electric blower 260 is largely independent of placement which allows a great deal of latitude in placement of the electric blower. This latter latitude in placement permits the electric blower 260 to be placed in a location away from the mow deck 110 and an orientation that may be freely selected. As shown in FIG. 2, there are many options for placement and orientation of the electric blower 260. Also as shown in FIG. 2 and with further reference to FIG. 4, because the blower is not required to be placed at or near the deck, as shown in FIG. 1 and FIG. 5, the discharge chute 210 may be freed from the complex double curved path 512 associated with such placement shown in FIG. 5. It has been found that a less complex discharge chute 210 that follows a simple chute elongation path 412 may result in less flow resistance and thus more efficiency.

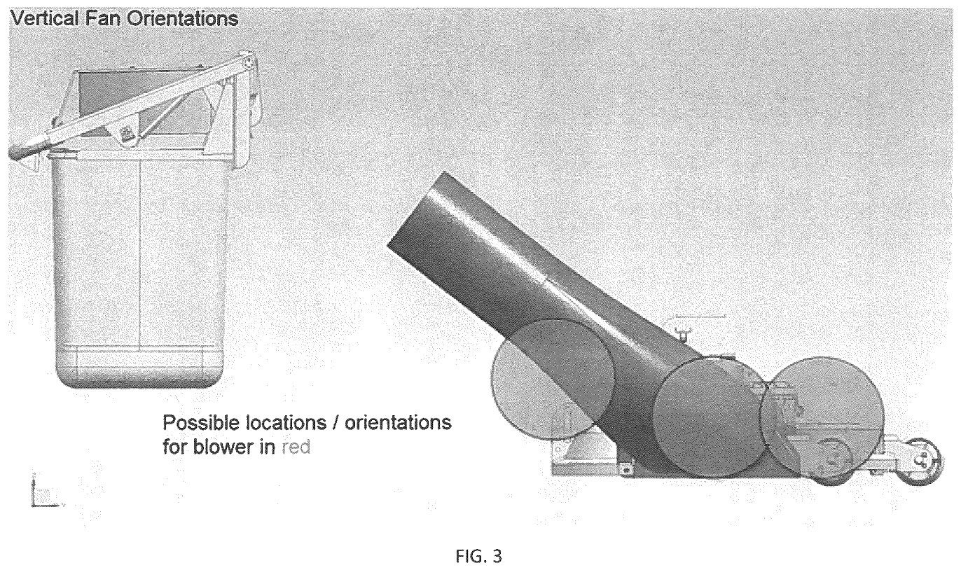

As noted above, in applications in which the trimmings are to be bagged, it is typical to convey the trimming mixture 1680 from the deck output 120 to the bag 180 through the discharge chute 210. In the embodiment shown in FIGS. 2-4, 6-8, the discharge chute 210 is elongated along the chute elongation path 412 to define a chute input 214 and a chute output 216. Accordingly, the chute output 216 is offset from the chute input 214 by the chute elongation path 412. The chute input 214 may be operatively engaged to the deck output 120 to receive the trimming mixture 1680 therefrom by any means chosen with good engineering judgment. The discharge chute 210 is adapted to convey at least part of the trimming mixture 1680 along the discharge chute 210 to the chute output 216 and from there to the bag 180. In some embodiments, it is desirable to convey all or nearly all of the trimming mixture input to the discharge chute 210 to the chute output 216 and from there to the bag 180.

In order to promote conveyance of the trimming mixture 1680 through the discharge chute 210 to the chute output 216 and from there to the bag 180, some embodiments employ an electric blower 260 to energize the flow within the discharge chute 210. An electric blower 260 may have a blower intake 1462 and a blower ejection 1364. In operation, the electric blower 260 intakes air or a trimming mixture 1680 through the blower intake 1462, energizes the air or a trimming mixture 1680 in the sense of increasing flow speed or flow pressure or both, and ejects the energized air or trimming mixture 1680 as an energized fluid stream through the blower ejection 1364 and into the discharge chute at a location on the chute elongation path 412 between the chute input 214 and the chute output 216.

In operation, the electric blower 260 is adapted to operate at some blower speed to output the energized fluid stream into the discharge chute 210. The blower speed may be readily adjustable and may be a function of blade speed and/or other operational speeds or may be independent of blade speed and other operational speeds. In some aspects, the blower may have an operational maximum blower speed determined by the blower manufacturer, or by power requirements, or other engineering considerations. In some embodiments, blower speed may be directly adjusted by an associated user in some range of speeds between some minimum speed and some maximum speed that may be the operational maximum blower speed. Alternatively, in some embodiments, the blower speed is adjustable independently of the blade speed among a plurality of discrete blower speeds. By way of example of the latter aspects, and without limitation, a user may select any of: 1) a low blower speed that is some fixed RPM X, or 2) a medium blower speed that is some fixed RPM Y, or 3) a high blower speed that is some fixed RPM Z, where X<Y<Z. Alternatively, in some embodiments, the blower speed is adjustable to some rate that is a function of the blade speed among a plurality of discrete blower speed options. By way of example of the latter aspects, and without limitation, a user may select 1) a low blower speed that is some fixed proportion A of blade speed such that blower speed (R) is a linear function of blade speed (S) where R=(A)(S); or 2) a medium blower speed that is some fixed proportion B of blade speed such that blower speed (R) is a linear function of blade speed (S) where R=(B)(S); or 3) a high blower speed that is some fixed proportion C of blade speed such that blower speed (R) is a linear function of blade speed (S) where R=(C)(S), where A<B<C. Other blower speed adjustment options are also contemplated. In some embodiments, there may be means to detect if trimmings are accumulating or have accumulated in the discharge chute, e.g. by detecting weight or mass of the chute and contents, and to provide for the blower speed to be automatically adjusted to some minimum speed that is sufficient to discharge accumulated trimmings and prevent trimmings from accumulating in the discharge chute. In some embodiments, blower speed may be a function of the current load of the set of blade motors such that the blower speed will automatically be increased if the system recognizes an increased electrical load at the set of blade motors.

In some embodiments, it has been discovered that the operation of the blower at or above some non-zero minimum speed substantially reduces or prevents accumulation of trimmings at the blower. This latter non-zero minimum speed will be referred to herein as the “zephyr speed”. The zephyr speed may be particular to any given system and may depend on or be a function of design features such as the angle of the blower output stream, i.e., energized fluid stream direction 696, with respect to the chute elongation path 412 (see below) or the choice of input to the blower intake 1462 (see below), or the shape of the discharge chute 210, or the size of the discharge chute 210, or the Reynold's Number of the flow of the trimming mixture in the discharge chute, or some combination thereof. It may be of interest in systems with adjustable blower speed to set the adjustment parameters using zephyr speed of the system as an input datum. As noted above, in some aspects of systems with adjustable blower speed, the blower may have an operational maximum blower speed determined by the blower manufacturer, or by power requirements, or other engineering considerations. Accordingly, in some embodiments, the blower speed is adjustable to one or more rates among a plurality of discrete blower speed options, where each rate is a function of the blade speed, zephyr speed, and operational maximum blower speed. By way of example of the latter aspects, and without limitation, a user may select 1) a low blower speed that is some fixed proportion A of blade speed such that blower speed (R) is a linear function of blade speed (S), maximum operational blade speed (S_max), maximum operational blower speed (R_max), and the zephyr speed of the blower (Z), where R=(A)(R_max−Z)(S)/(S_max)+Z; or 2) a medium blower speed that is some fixed proportion B of blade speed such that blower speed (R) is a linear function of blade speed (S) where R=(B)(R_max−Z)(S)/(S_max)+Z; or 3) a high blower speed that is some fixed proportion C of blade speed such that blower speed (R) is a linear function of blade speed (S) where R=(C)(R_max−Z)(S)/(S_max)+Z, where A<B<C. The above disclosure is non-limiting and it is contemplated that in some alternative aspects to the latter aspect, there may be rather than 3 discrete speed options, 2, 4, 5, 6, 7, 8, or more discrete speed options for a user to select among. It should be understood that while some systems have a non-zero zephyr speed, not all systems do, and in some systems the blower can be shut off without substantial accumulation of trimmings at the blower.

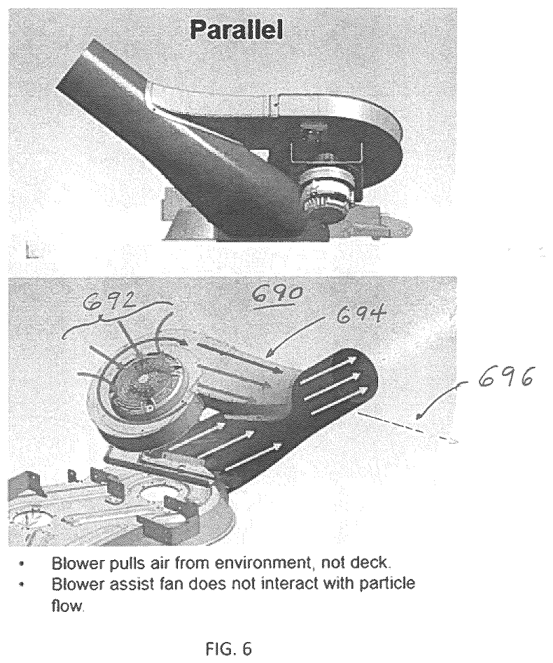

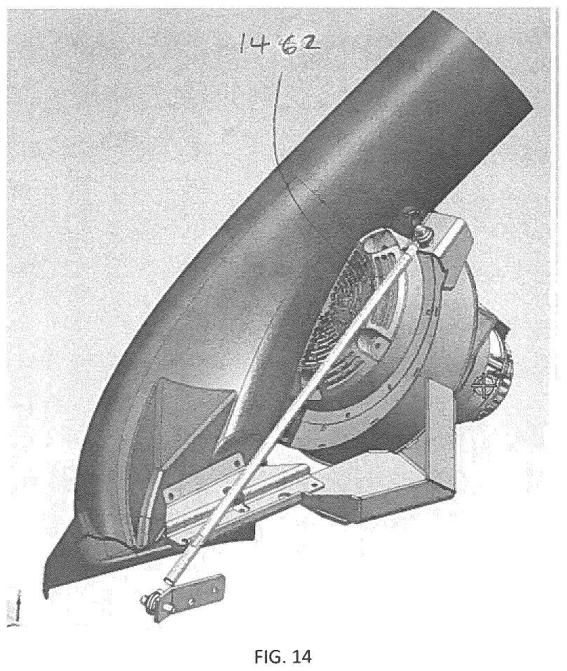

With reference now particularly to FIG. 6 and also to FIGS. 2, 13 and 14, in some aspects of a lawn maintenance device with blower assisted bagging, the blower intake 1462, may be entirely outside of the discharge chute 210. With continued reference to FIG. 6, in such an aspect, the blower ejection 1364 is located within the discharge chute 210 along the chute elongation path 412 between the chute input 214 and the chute output 216. With continued reference to FIG. 6, in such an aspect, all of the fluid that enters the blower intake 1462 is taken from the ambient air 692 of the environment 690. This latter aspect may be understood to be a parallel flow aspect. The air 692 taken in by the blower 260 is then accelerated without the addition of any trimming mixture 1680 and expelled from the blower 260 through the blower ejection 1364. This latter action can be understood to add energy to the trimming mixture within the discharge chute 210 in the form of added flowing air to promote flow and thereby facilitate ejection of the trimming mixture 1680 from the chute output 216. It should be noted that the energized fluid stream 694 being expelled from the blower ejection 1364 may be understood to have a direction 696. It should be further understood that the energized fluid stream 694 direction 696 is a vector that may have some orientation or angle relative to the chute elongation path 412. Also, direction 696 and the chute elongation path 412 will generally be co-planar or sufficiently close to co-planar as to be treated as such without introducing important error. The angle of direction 696 to the chute elongation path 412 may be a design choice but may be within 70 degrees to one another, within 60 degrees to one another, within 50 degrees to one another, within 40 degrees to one another, within 30 degrees to one another, within 20 degrees to one another, within 10 degrees to one another, or may be approximately parallel to one another.

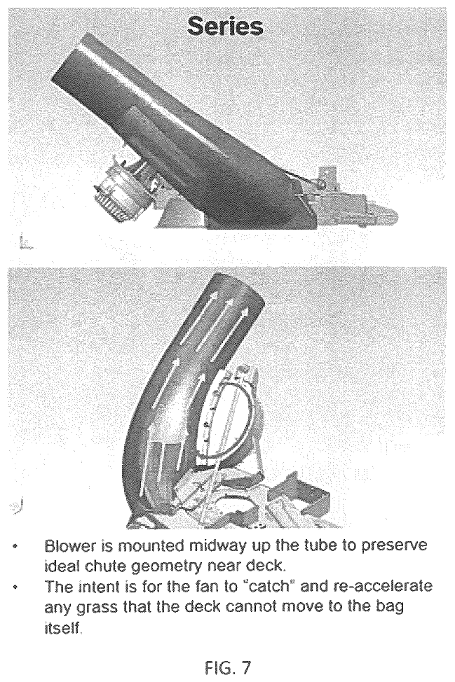

With reference now particularly to FIG. 7 and also to FIGS. 2, 6, 13 and 14, in some aspects of a lawn maintenance device with blower assisted bagging, the blower intake 1462, may be entirely contained within the discharge chute 210. With continued reference to FIG. 7, in such an aspect, the blower 260 is located on the chute elongation path 412 between the chute input 214 and the chute output 216. With continued reference to FIG. 7, in such an aspect, all of the fluid that enters the blower intake 1462 is the trimming mixture 1680 within the discharge chute. This latter aspect may be understood to be a series flow aspect. The trimming mixture taken in by the blower 260 is then accelerated without the addition of any further air and expelled from the blower 260 through the blower ejection 1364 which is also entirely within the discharge chute 210. This latter action can be understood to add energy to the trimming mixture within the discharge chute 210 by accelerating it to promote flow and thereby facilitate ejection of the trimming mixture from the chute output 216.

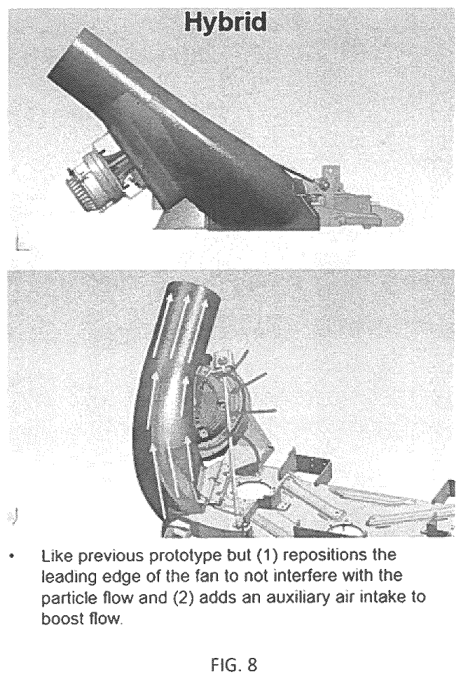

With reference now particularly to FIG. 8 and also to FIGS. 2, 6, 13 and 14, in some aspects of a lawn maintenance device with blower assisted bagging, the blower intake 1462, may be partially outside of the discharge chute 210 and be partially contained within the discharge chute 210. With continued reference to FIG. 8, in such an aspect, the blower ejection 1364 is located within the discharge chute 210 along the chute elongation path 412 between the chute input 214 and the chute output 216. With continued reference to FIG. 8, in such an aspect, some of the fluid that enters the blower intake 1462 is taken from the ambient air 692 of the environment 690 and some of the fluid that enters the blower intake 1462 is the trimming mixture 1680 within the discharge chute. This latter aspect may be understood to be a hybrid flow aspect, in the sense of a hybrid of the previously described parallel flow aspect and the previously described serial flow aspect. The ratio of the fluids that enter the blower intake 1462, in the sense of the ratio of ambient air 692 to trimming mixture 1680 may be a design choice but in some aspects is within a range from 90% ambient air 692 to 10% ambient air 692 (with the margin in each case being the trimming mixture 1680); within a range from 80% ambient air 692 to 20% ambient air 692; within a range from 70% ambient air 692 to 30% ambient air 692; within a range from 60% ambient air 692 to 40% ambient air 692; or approximately 50% ambient air 692. With continued reference to FIG. 8, in such an aspect, the ambient air 692 and trimming mixture 1680 taken in by the blower 260 is then accelerated and expelled from the blower 260 through the blower ejection 1364. This latter action can be understood to add energy to the trimming mixture within the discharge chute 210 in the form of both adding flowing air to promote flow and accelerating the trimming mixture to thereby facilitate ejection of the trimming mixture 1680 from the chute output 216.

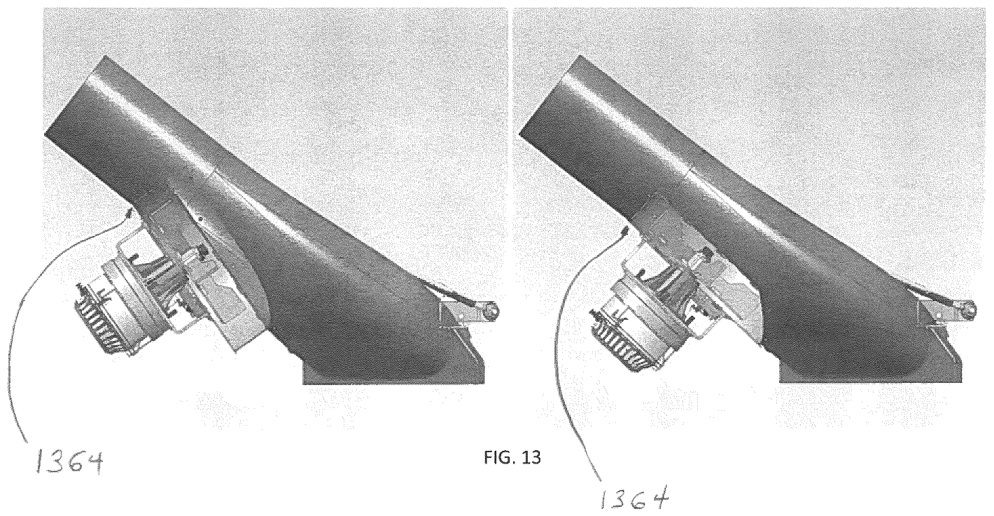

With reference now to FIG. 13, shown are two alternative aspects of a hybrid flow arrangement. As can be seen, in one view, the blower is angled such that the blower blades on the side of the blower closer to the chute input are outside of the flow stream within the discharge chute. In the second view, the blower is angled such that the blower blades on the side of the blower closer to the chute input are within the flow stream within the discharge chute.

In some embodiments and operational conditions, experiments have shown evidence that the blower may pull a vacuum on the deck. Pulling a vacuum on the deck may be beneficial for decreasing the amount of clippings left on the cut surface, so the blower may facilitate performance by adding energy to the trimming mixture, or pulling a vacuum on the deck, or both.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. The block diagrams of the architecture and flow charts are grouped for ease of understanding. However, it should be understood that combinations of blocks, additions of new blocks, re-arrangement of blocks, and the like are contemplated in alternative embodiments of the present disclosure.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A lawn maintenance device with blower assisted bagging, comprising:
a deck having a blade set mounted thereon, said blade set adapted to be operated at some blade speed to trim vegetation to generate trimmings, said deck further having a deck output adapted to eject therefrom a trimming mixture formed of the trimmings suspended in air;
an elongated discharge chute defining a chute input and a chute output, the chute output offset from the chute input by a chute elongation path, the chute input operatively engaged to the deck output to receive the trimming mixture, the discharge chute being adapted to convey at least part of the trimming mixture along the chute to the chute output; and
an electric blower having a blower intake and a blower ejection, the blower adapted to operate at some blower speed to output an energized fluid stream into the discharge chute at a location on the chute elongation path between the chute input and the chute output.

2. The lawn maintenance device with blower assisted bagging of claim 1, wherein the blower speed is adjustable by a user.

3. The lawn maintenance device with blower assisted bagging of claim 1, wherein the blower speed is adjustable independently of the blade speed among a plurality of discrete blower speeds.

4. The lawn maintenance device with blower assisted bagging of claim 1, wherein the blower intake is entirely contained within the discharge chute.

5. The lawn maintenance device with blower assisted bagging of claim 4, wherein the blower speed is adjustable independently of the blade speed among a plurality of discrete blower speeds.

6. The lawn maintenance device with blower assisted bagging of claim 1, wherein the blower intake is entirely outside of the discharge chute.

7. The lawn maintenance device with blower assisted bagging of claim 6, wherein the blower speed is adjustable independently of the blade speed among a plurality of discrete blower speeds.

8. The lawn maintenance device with blower assisted bagging of claim 1, wherein the blower intake is partially outside of the discharge chute and partially inside the discharge chute.

9. The lawn maintenance device with blower assisted bagging of claim 8, wherein the blower speed is adjustable independently of the blade speed among a plurality of discrete blower speeds.

10. The lawn maintenance device with blower assisted bagging of claim 8, wherein the blower speed is user selectable among a plurality of linear functions of blade speed wherein, in each of the plurality of linear functions of blade speed, the blower speed varies linearly between a non-zero zephyr speed and a pre-determined percentage of maximum operational blower speed.

11. A method of using a lawn maintenance device with blower assisted bagging, comprising:
providing a lawn maintenance device with blower assisted bagging, the lawn maintenance device with blower assisted bagging having,
a deck having a blade set mounted thereon, said blade set adapted to be operated at some blade speed to trim vegetation to generate trimmings, said deck further having a deck output adapted to eject therefrom a trimming mixture formed of the trimmings suspended in air,
an elongated discharge chute defining a chute input and a chute output, the chute output offset from the chute input by a chute elongation path, the chute input operatively engaged to the deck output to receive the trimming mixture, the discharge chute being adapted to convey at least part of the trimming mixture along the chute to the chute output, and
an electric blower having a blower intake and a blower ejection, the blower adapted to operate at some blower speed to output an energized fluid stream into the discharge chute at a location on the chute elongation path between the chute input and the chute output;
generating trimmings by operating the blade set at some first operational speed to trim vegetation;
ejecting from the deck output the trimmings as a trimming mixture of trimmings mixed in air;
receiving the trimming mixture in the discharge chute; and
operating the electric blower to at some first blower speed to output an energized fluid stream into the discharge chute.

12. The method of using a lawn maintenance device with blower assisted bagging of claim 11, wherein the blower speed is adjustable by a user.

13. The method of using a lawn maintenance device with blower assisted bagging of claim 11, wherein the blower speed is adjustable independently of the blade speed among a plurality of discrete blower speeds.

14. The method of using a lawn maintenance device with blower assisted bagging of claim 11, wherein the blower intake is entirely contained within the discharge chute.

15. The method of using a lawn maintenance device with blower assisted bagging of claim 14, wherein the blower speed is adjustable independently of the blade speed among a plurality of discrete blower speeds.

16. The method of using a lawn maintenance device with blower assisted bagging of claim 11, wherein the blower intake is entirely outside of the discharge chute.

17. The method of using a lawn maintenance device with blower assisted bagging of claim 16, wherein the blower speed is adjustable independently of the blade speed among a plurality of discrete blower speeds.

18. The method of using a lawn maintenance device with blower assisted bagging of claim 11, wherein the blower intake is partially outside of the discharge chute and partially inside the discharge chute.

19. The method of using a lawn maintenance device with blower assisted bagging of claim 18, wherein the blower speed is user selectable among a plurality of linear functions of blade speed wherein, in each of the plurality of linear functions of blade speed, the blower speed varies linearly between a non-zero zephyr speed and a pre-determined percentage of maximum operational blower speed.

20. A lawn maintenance device with blower assisted bagging, comprising:
a deck having a blade set mounted thereon, said blade set adapted to be operated at some blade speed to trim vegetation to generate trimmings, said deck further having a deck output adapted to eject therefrom a trimming mixture formed of the trimmings suspended in air;
an elongated discharge chute defining a chute input and a chute output, the chute output offset from the chute input by a chute elongation path, the chute input operatively engaged to the deck output to receive the trimming mixture, the discharge chute being adapted to convey at least part of the trimming mixture along the chute to the chute output;
an electric blower having a blower intake and a blower ejection, the blower adapted to operate at some blower speed to output an energized fluid stream into the discharge chute at a location on the chute elongation path between the chute input and the chute output;
wherein the blower intake is partially outside of the discharge chute and partially inside the discharge chute;
wherein the blower speed is user selectable among at least two linear functions of blade speed wherein, in each of the at least two linear functions of blade speed, the blower speed varies linearly between a non-zero zephyr speed and a pre-determined percentage of maximum operational blower speed wherein in one of the at least two linear functions the blower speed varies linearly between a non-zero zephyr speed and 100% of maximum operational blower speed; and
wherein the energized fluid stream is along a direction is an angle of within 20 degrees to the chute elongation path.
